(19) United States
(12) Patent Application Publication
(10) Pub. No.: US 2026/0218879 A1
(43) Pub. Date: Jul. 30, 2026

(54) COMBINATION COVER FOR NICHELESS LIGHT

(71) Applicant: Zodiac Pool Systems LLC, Carlsbad, CA (US)

(72) Inventors: Mark J. Bauckman, San Marcos, CA (US); Ricky Lo, Carlsbad, CA (US)

(73) Assignee: Zodiac Pool Systems LLC, Carlsbad, CA (US)

(21) Appl. No.: 19/457,804

(22) Filed: Jan. 23, 2026

Related U.S. Application Data
(60) Provisional application No. 63/750,654, filed on Jan. 28, 2025.

(51) Int. Cl. F21V 5/04; F21W 131/401

(52) U.S. Cl. CPC F21V 5/04; F21W 2131/401

(57) ABSTRACT

A pool lighting assembly for a swimming pool or spa includes a pool light and a pool light cover. The pool light cover may cover a lens of the pool light while allowing at least some light emitted from the pool light to pass through the pool light cover. A method of installing a pool light includes installing a pool light assembly at a location within a pool or spa and detecting light from a pool light of the pool light assembly without removing the light cover of the pool light assembly.

### REFERENCE TO RELATED APPLICATION

This application claims the benefit of and priority to U.S. Provisional Ser. No. 63/750,654, filed on Jan. 28, 2025, and entitled COMBINATION COVER FOR NICHELESS LIGHT, the content of which is hereby incorporated by reference in its entirety.

### FIELD OF THE INVENTION

The invention relates to immersed lighting assemblies principally for swimming pools and spas, and more particularly, but not necessarily exclusively, to lighting systems having improved installation.

### BACKGROUND OF THE INVENTION

Water within a swimming pool or spa sometimes may be illuminated by underwater lighting systems. As identified in U.S. Pat. No. 6,971,760 to Archer, et al., whose contents are incorporated in their entirety herein by this reference, existing underwater lighting systems may include those lighting assemblies that require a cavity or niche in the wall or surface of the pool below the waterline and those lighting systems where a niche does not need to be formed to provide the underwater pool light (also known as “nicheless” lighting assemblies).

During installation of such lighting assemblies, the lighting assemblies may be dragged and/or dropped by an installer, and/or may be exposed to other installation steps (e.g., plastering with a trowel, etc.), potentially damaging or otherwise compromising the lens of the lighting assemblies. Some pool lights, such as those described in U.S. Pat. No. 11,035,564 to Arpin et al. (“Arpin”), the content of which is hereby incorporated by reference in its entirety, may include a light cover. The light covers described in Arpin are temporary or permanent. However, the temporary light covers of Arpin are commonly removed mid-installation to initially set the light assembly and check the light assembly, thereby leaving the pool light exposed and susceptible to damage for the remainder of the projection. Moreover, not all installations desire and/or permit permanent light covers.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a pool light cover for a pool light is configured to extend over a lens of the pool light while allowing at least some light emitted from the pool light to pass through the pool light cover.

According to various embodiments, a pool light cover for a pool light includes a light guide and at least one aperture such that when the pool light cover is assembled on the pool light, at least some light from the pool light is directed through the light guide and the aperture.

According to some embodiments, a pool light cover for a pool light includes an installation tab. In various embodiments, the installation tab includes at least one aperture for receiving light from the pool light.

According to various embodiments, a pool light cover for a pool light includes an installation tab. In certain embodiments, at least a portion of the pool light cover is transparent and/or translucent.

According to certain embodiments, a method of installing a pool light includes (i) installing a pool light assembly at a location within a pool, the pool light assembly comprising a pool light and a light cover covering the pool light, and (ii) detecting light from the pool light without removing the light cover.

According to various embodiments, a pool lighting assembly includes the pool light and the light cover.

According to some embodiments, a pool lighting assembly is a nicheless pool lighting assembly with the pool light and the light cover.

According to various embodiments, a pool lighting assembly for a swimming pool or spa includes a pool light and a pool light cover. The pool light cover is configured to cover a lens of the pool light while allowing at least some light emitted from the pool light to pass through the pool light cover.

According to certain embodiments, a pool light cover for a pool light includes a base portion and an installation tab. The pool light cover is configured to cover a lens of the pool light while allowing at least some light emitted from the pool light to pass through the pool light cover.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates a pool lighting assembly with a pool light and a light cover according to embodiments.

FIG. 2 illustrates the pool light of the pool lighting assembly of FIG. 1 according to embodiments.

FIG. 3 illustrates the light cover of the pool lighting assembly of FIG. 1 according to embodiments.

FIG. 4 is another view of the light cover of the pool lighting assembly of FIG. 1 according to embodiments.

FIG. 5 illustrates the pool lighting assembly of FIG. 1 installed at an installation location in a pool according to embodiments.

### DETAILED DESCRIPTION

Described herein are pool lighting assemblies with improved light covers for pool lights, such as but not limited to nicheless pool lights. In some embodiments, the light covers described herein may include a light guide and/or may be capable of transmitting light through at least a portion of the light cover, optionally the entire cover. In certain embodiments, the light covers are capable of transmitting light from a light source of the pool light which is otherwise covered by the light cover when the light cover is installed on the pool light. The light covers transmitting light may allow an installer to inspect the light without removal of the cover. In certain embodiments, the light covers described herein may include an installation tab to facilitate handling of the light cover and/or a pool light attached thereto. Optionally, one or more apertures for the light guide may be provided on the installation tab. Additionally, or alternatively, the light cover may be at least partially transparent and/or at least partially translucent. Optionally, the light cover (or a portion thereof) may be constructed from a transparent and/or translucent material.

In various embodiments, the light covers described herein are configured to engage a pool light and facilitate installation to a wall fitting. The light covers described herein may provide protection against dragging and dropping of the lights as well as plastering, troweling, and other installation steps around the pool lights during installation. In some embodiments, the light covers described herein may be installed by a supplier and optionally may only be removed after the completion of the project. The light covers described herein may further reduce the number of parts or components needed during the installation of a lighting assembly, thereby providing cost, material, and labor savings for an installation. Various other benefits and advantages may be realized with the systems, devices, and methods provided herein, and the aforementioned advantages should not be considered limiting.

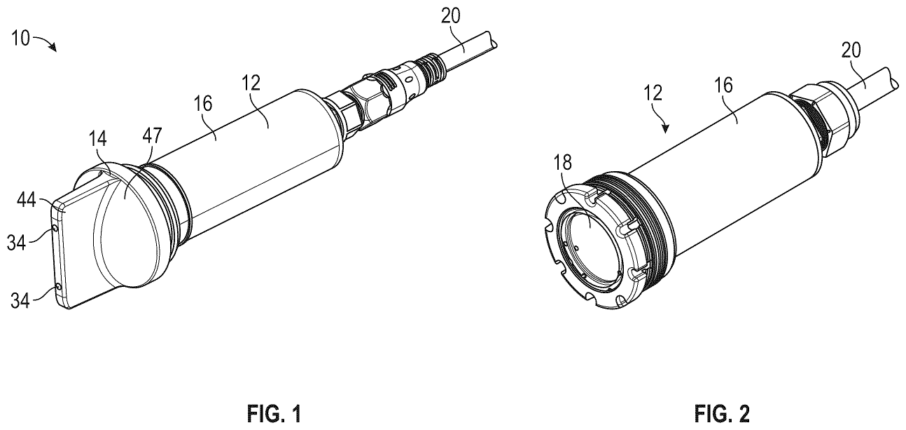

FIGS. 1-5 illustrate a lighting assembly 10 which includes a pool light 12 and a light cover 14 according to embodiments.

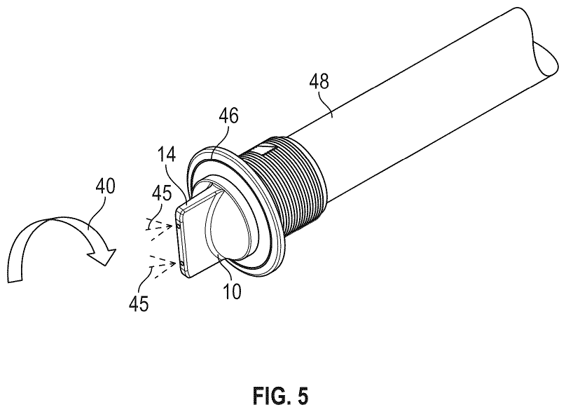

The pool light 12 may be various types of pool lights as desired, and in some embodiments may be similar to those pool lights described in Arpin. In one non-limiting example, the pool light 12 may be a nicheless pool light. In such embodiments, the nicheless pool light may be mounted directly in a wall or surface of a pool or spa, and need not require a niche. Optionally, nicheless pool lights may be installed at or in a wall fitting 46 and/or piping 48 as illustrated in FIG. 5. In some embodiments, and as illustrated in FIG. 2, the pool light 12 may generally include a housing 16 and a lens 18. One or more light sources (e.g., LEDs) and/or other electronic components may be at least partially housed within the housing 16 and/or under the lens 18. Light emitted from the one or more light sources may be directed at least partially through the lens 18. Electrical and/or optical wiring 20 may further be connected to the pool light 12.

The light cover 14 may be selectively attachable to and detachable from the pool light 12, thereby selectively covering at least a portion of the pool light 12 when the light cover 14 is installed with the pool light 12. The light cover 14 may be attachable to and detachable from the pool light 12 using various attachment features as desired and described in detail below, such as but not limited to threading, snap-fit connections, friction fit connections, hooks, pins, other engagement features, combinations thereof, and/or as otherwise desired. In certain embodiments, the light cover 14 may provide protection against dragging and/or dropping of the light 12. Additionally, or alternatively, the light cover 14 may provide protection against plastering, troweling, and/or other installation steps around the pool light 12 during installation. In some embodiments, the light cover 14 may be installed by a supplier and optionally may only be removed after the completion of the project.

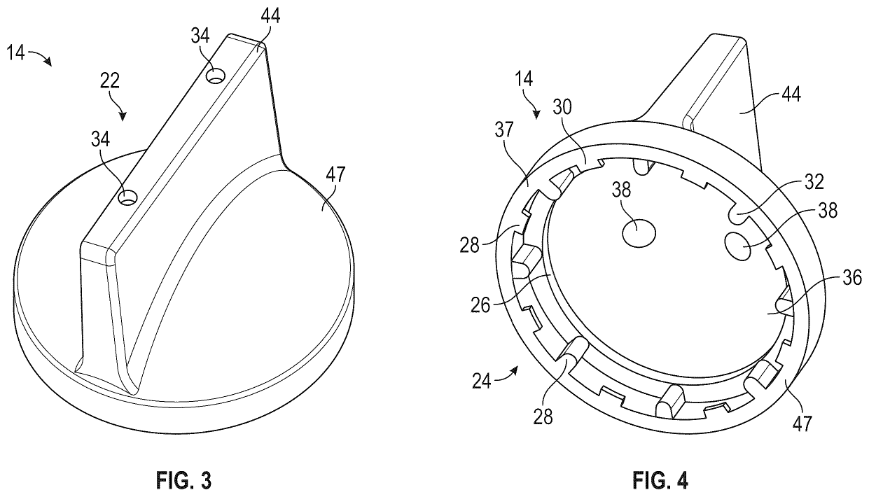

As best illustrated in FIGS. 3 and 4, the light cover 14 generally includes a top side 22 and a bottom side 24. The light cover 14 may have various constructions as desired. In some embodiments, the light cover 14 is a two or mutli-piece construction, optionally including a substrate portion 36 and an overmold portion 37, although it need not be in other embodiments. In some embodiments, the light cover 14 optionally is a monolithic or one-piece construction.

In certain embodiments, the light cover 14 and/or a portion thereof (such as but not limited to the substrate portion 36 and/or the overmold portion 37) may be constructed from and/or include a transparent or translucent material such that light may at least partially pass through the light cover 14. In some embodiments, the light cover 14 may be partially translucent and/or transparent, and optionally, the entire light cover 14 may be translucent and/or transparent. Optionally, and as discussed in detail below, the light cover 14 need not be translucent and/or transparent, and the light cover 14 may include other features allowing light to at least partially pass through the light cover 14. Various materials suitable for protecting the lens 18 of the pool light 12 may be utilized for the light cover 14 as desired.

Referring to FIG. 4, the bottom side 24 of the light cover 14 defines a receiving area 26 which is shaped and otherwise configured to receive and/or accommodate at least the lens 18 of the pool light 12. In some embodiments, the light cover 14 includes attachment features 28 for facilitating engagement of the light cover 14 to the pool light 12. Various attachment features 28 may be utilized as desired, such as but not limited to one or more snap hooks 30, one or more alignment ribs 32, threading, snap-fit connections, friction fit connections, hooks, pins, other engagement features, combinations thereof, and/or other devices or mechanisms as desired.

In certain embodiments, and as best illustrated in FIG. 3, the top side 22 of the light cover 14 optionally includes one or more apertures 34. As represented by the dashed lines in FIG. 5, when the light cover 14 is on the pool light 12, at least a portion of the light 45 emitted by the pool light 12 may pass through the apertures 34 of the light cover 14 such that the light 45 is visible. In this manner, an installer may be able to check the status and/or performance of the pool light 12 during installation without having to remove the light cover 14. The number and location of the apertures 34 should not be considered limiting. In certain embodiments, the light cover 14 may include one or more light guides 38 for directing light from the pool light 12 to the apertures 34 on the top side 22. In embodiments where the light cover 14 includes a translucent and/or transparent material, the light cover 14 may or may not include the one or more apertures 34. As a non-limiting example, the base portion 47 may be translucent and/or transparent and/or a tab 44 may be translucent and/or transparent, optionally allowing for the passage of light through the light cover 14 without necessarily needing aperture 34.

In various embodiments, the top side 22 of the light cover 14 may include an installation ridge or tab 44 extending outwards from a base portion 47 of the light cover 14. In some embodiments, the installation tab 44 is elongated across the base portion 47 of the light cover 14. Optionally, the installation tab 44 may span a transverse dimension, such as but not limited to diameter, of the base portion 47. However, in other embodiments, the installation tab 44 may have other shapes or profiles as desired, and the shape or profile of the installation tab 44 illustrated in FIGS. 1-5 should not be considered limiting. Optionally, the one or more apertures 34 may be provided in the installation tab 44 as illustrated in FIG. 3, although they need not be in other embodiments. Optionally, when the light cover 14 includes at least a portion with transparent and/or translucent material, the installation tab 44 may at least partially include the transparent and/or translucent material.

The installation tab 44 on the top side 22 of the light cover 14 may allow for the light cover 14 to function both as a protective cover and an installation tool. As a non-limiting example, when the light cover 14 is provided on the pool light 12, an installer may grip the installation tab 44 to position both the light cover 14 and the pool light 12 relative to an installation location in a pool system with a pool or spa. As a non-limiting example and as illustrated in FIG. 5, an installation location may include a wall fitting 46 and/or piping 48 provided on and/or extending into a surface of the pool or spa, such as but not limited to a floor or wall of the pool or spa. The lighting assembly 10 may be installed at other installation locations in a pool system as desired. In embodiments during installation, the installation tab 44 may further be utilized to install the pool light 12 and light cover 14 at the installation location, such as by facilitating rotation of the pool light 12 (e.g., to engage threading of the wall fitting 46 and/or piping 48), linear movement of the pool light 12, combinations thereof, and/or as otherwise desired.

Referring to FIG. 5, a method of installing the lighting assembly 10 at the installation location may include assembling the light cover 14 with the pool light 12. In some embodiments, the light cover 14 may be assembled with the pool light 12 by the supplier and/or manufacturer of the lighting assembly 10. The method may include positioning the lighting assembly 10 such that the wiring 20 is directed through the piping 48 and the lens side of the pool light 12 is configured to face the body of water in which the lighting assembly 10 is installed. In certain embodiments, the method includes installing the lighting assembly 10 with the wall fitting 46 and/or piping 48 by rotating the lighting assembly 10 (see, e.g., arrow 40) using the installation tab 44 and such that the lighting assembly 10 threadably engages the wall fitting 46 and/or the piping 48. In some embodiments, the method includes rotating the lighting assembly 10 until the lighting assembly 10 is flush with the wall fitting 46 and/or the piping 48.

In some embodiments, the method includes inspecting the pool light 12 and/or detecting light from the pool light 12 without removing the light cover 14. In such embodiments, the method may include activating a light source of the pool light 12, and detecting light from the pool light 12 via the one or more apertures 34 of the light cover 14. Additionally, or alternatively, the method may include detecting light from the pool light 12 via at least a portion of the light cover 14 that is transparent and/or translucent. Optionally, the method may include detecting light from the pool light 12 via at least a portion of the installation tab 44 and/or the base portion 47 that is transparent and/or translucent.

In various embodiments, the method may include maintaining the light cover 14 on the pool light 12 through a duration of the pool installation projection and/or until construction is complete. As non-limiting examples, the method may include maintaining the light cover 14 on the pool light 12 through a plastering and/or troweling installation step.

In certain embodiments, the method includes removing the light cover 14 from the pool light 12 after construction is complete.

Various other benefits and advantages may be realized with the systems, devices, and methods provided herein, and the aforementioned advantages should not be considered limiting.

Exemplary concepts or combinations of features of the invention may include:
A. A pool light cover for a pool light, the pool light cover configured to extend over a lens of the pool light while allowing at least some light emitted from the pool light to pass through the pool light cover.
B. A pool light cover for a pool light, the pool light cover comprising a light guide and at least one aperture such that when the pool light cover is assembled on the pool light, at least some light from the pool light is directed through the light guide and the aperture.
C. A pool light cover for a pool light, the pool light cover comprising an installation tab, the installation tab comprising at least one aperture for receiving light from the pool light.
D. A pool light cover for a pool light, the pool light cover comprising an installation tab, wherein at least a portion of the pool light cover is transparent and/or translucent.
E. A method of installing a pool light, the method comprising:
   i. installing a pool light assembly at a location within a pool, the pool light
   assembly comprising a pool light and a light cover covering the pool light; and
   ii. detecting light from the pool light without removing the light cover.
F. A pool lighting assembly for a swimming pool or spa comprises a pool light and a pool light cover, wherein the pool light cover is configured to cover a lens of the pool light while allowing at least some light emitted from the pool light to pass through the pool light cover.
G. A pool light cover for a pool light comprises a base portion and an installation tab, wherein the pool light cover is configured to cover a lens of the pool light while allowing at least some light emitted from the pool light to pass through the pool light cover.
H. The pool lighting assembly, pool light cover, and/or method of any preceding or subsequent statement or combination of statements, wherein the pool light is a nicheless pool light.
I. The pool lighting assembly, pool light cover, and/or method of any preceding or subsequent statement or combination of statements, wherein the pool light cover comprises an installation tab, and wherein the installation tab comprises at least one aperture for receiving light from the pool light and allowing the light to pass through the pool light cover.
J. The pool lighting assembly, pool light cover, and/or method of any preceding or subsequent statement or combination of statements, wherein at least a portion of the pool light cover is transparent or translucent.
K. The pool lighting assembly, pool light cover, and/or method of any preceding or subsequent statement or combination of statements, wherein the pool light cover comprises a base portion and an installation tab extending outwards from the base portion, and wherein the base portion is transparent or translucent.
L. The pool lighting assembly, pool light cover, and/or method of any preceding or subsequent statement or combination of statements, wherein the pool light cover comprises a base portion and an installation tab extending outwards from the base portion, and wherein the installation tab is transparent or translucent.
M. The pool lighting assembly, pool light cover, and/or method of any preceding or subsequent statement or combination of statements, wherein the pool light cover comprises an aperture for receiving light from the pool light and allowing the light to pass through the pool light cover.
N. The pool lighting assembly, pool light cover, and/or method of any preceding or subsequent statement or combination of statements, wherein the pool light cover further comprises a light guide, wherein at least some light from the pool light is directed through the light guide and the aperture.
O. The pool lighting assembly, pool light cover, and/or method of any preceding or subsequent statement or combination of statements, wherein the pool light cover further comprises attachment features for attaching the pool light cover with the pool light, wherein the attachment features comprise one or more snap hooks and one or more alignment ribs.
P. The pool lighting assembly, pool light cover, and/or method of any preceding or subsequent statement or combination of statements, wherein the at least one aperture comprises two apertures.
Q. The pool lighting assembly, pool light cover, and/or method of any preceding or subsequent statement or combination of statements, wherein the pool light cover is a two-piece construction comprising a base portion and an overmold portion.
R. 19. The pool lighting assembly, pool light cover, and/or method of any preceding or subsequent statement or combination of statements, wherein the pool light cover is a one-piece construction.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with swimming pools or spas, persons skilled in the relevant field will recognize that the present invention conceivably could be employed in connection with other water containing vessels and in other manners, particularly but not limited to underwater installations. Finally, references to “pools” and “swimming pools” herein may also refer to spas or other water containing vessels used for recreation, training, or therapy.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. In the figures and the description, like numerals are intended to represent like elements. As used herein, the meaning of “a,” “an,” and “the” includes singular and plural references unless the context clearly dictates otherwise.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

That which is claimed:

1. A pool lighting assembly for a swimming pool or spa comprises a pool light and a pool light cover, wherein the pool light cover is configured to cover a lens of the pool light while allowing at least some light emitted from the pool light to pass through the pool light cover.

2. The pool lighting assembly of claim 1, wherein the pool light is a nicheless pool light.

3. The pool lighting assembly of claim 1, wherein the pool light cover comprises an installation tab, and wherein the installation tab comprises at least one aperture for receiving light from the pool light and allowing the light to pass through the pool light cover.

4. The pool lighting assembly of claim 1, wherein at least a portion of the pool light cover is transparent or translucent.

5. The pool lighting assembly of claim 1, wherein the pool light cover comprises a base portion and an installation tab extending outwards from the base portion, and wherein the base portion is transparent or translucent.

6. The pool lighting assembly of claim 1, wherein the pool light cover comprises a base portion and an installation tab extending outwards from the base portion, and wherein the installation tab is transparent or translucent.

7. The pool lighting assembly of claim 1, wherein the pool light cover comprises an aperture for receiving light from the pool light and allowing the light to pass through the pool light cover.

8. The pool lighting assembly of claim 7, wherein the pool light cover further comprises a light guide, wherein at least some light from the pool light is directed through the light guide and the aperture.

9. The pool lighting assembly of claim 1, wherein the pool light cover further comprises attachment features for attaching the pool light cover with the pool light, wherein the attachment features comprise one or more snap hooks and one or more alignment ribs.

10. A pool light cover for a pool light comprises a base portion and an installation tab, wherein the pool light cover is configured to cover a lens of the pool light while allowing at least some light emitted from the pool light to pass through the pool light cover.

11. The pool light cover of claim 10, wherein the installation tab comprises at least one aperture for receiving light from the pool light and allowing the light to pass through the pool light cover.

12. The pool light cover of claim 11, wherein the at least one aperture comprises two apertures.

13. The pool light cover of claim 10, wherein at least a portion of the pool light cover is transparent or translucent.

14. The pool light cover of claim 10, wherein the installation tab extends outwards from the base portion, and wherein the base portion is transparent or translucent.

15. The pool light cover of claim 10, wherein the installation tab extends outwards from the base portion, and wherein the installation tab is transparent or translucent.

16. The pool light cover of claim 10, wherein the pool light cover comprises an aperture for receiving light from the pool light and allowing the light to pass through the pool light cover.

17. The pool light cover of claim 16, wherein the pool light cover further comprises a light guide, wherein at least some light from the pool light is directed through the light guide and the aperture.

18. The pool light cover of claim 10, wherein the pool light cover further comprises attachment features for attaching the pool light cover with the pool light, wherein the attachment features comprise one or more snap hooks and one or more alignment ribs.

19. The pool light cover of claim 10, wherein the pool light cover is a two-piece construction comprising a base portion and an overmold portion.

20. A method of installing a pool light, the method comprising:
installing a pool light assembly at a location within a pool, the pool light assembly comprising a pool light and a light cover covering the pool light; and
detecting light from the pool light without removing the light cover.
